(19) United States
(12) Patent Application Publication
(10) Pub. No.: US 2024/0354497 A1
(43) Pub. Date: Oct. 24, 2024

(54) Processing User Queries for a Virtual Agent

(71) Applicant: Freshworks Inc., San Mateo, CA (US)

(72) Inventors: Saurav CHAKRAVORTY, Chennai (IN); Ishmeet RAINA, Chennai (IN); Ashutosh DWIVEDI, Chennai (IN); Vishal RAMESH, Chennai (IN)

(21) Appl. No.: 18/136,259

(22) Filed: Apr. 18, 2023

(51) Int. Cl. G06F 40/20; G10L 15/06; G10L 15/16

(52) U.S. Cl. CPC G06F 40/20; G10L 15/063; G10L 15/16

(57) ABSTRACT

A method of processing user queries for a virtual agent is provided. Data representing a user query directed to a virtual agent is received. It is determined whether the user query corresponds to any one of a first plurality of predefined user intents, by processing the received data using a first classifier configured to classify user queries according to the first plurality of user intents. In response to a positive determination, first output data is generated based on a user intent of the first plurality of user intents to which the user query is determined to correspond. In response to a negative determination, the received data is processed using a second classifier to generate second output data, the second classifier being configured to classify user queries according to a second plurality of predefined user intents. A predetermined action is performed based on either the first or second output data.

### BACKGROUND OF THE INVENTION

### Field of the Invention

The present disclosure concerns methods of processing user queries for a virtual agent. The present disclosure also concerns apparatus and computer program products comprising non-transitory computer-readable storage media having computer-executable instructions which, when executed by a processor, cause a computing device to perform a method of processing user queries for a virtual agent.

### Description of the Related Technology

Virtual agents (also referred to as ‘chatbots’) are software applications that are used to conduct online conversations with users in lieu of providing direct contact with a human agent. Virtual agents may be used for a variety of purposes including customer service, information gathering, request routing, etc. Conversations may be conducted via one or more of text, speech, text-to-speech, or speech-to-text, for example. Typically, a user directs a query, e.g. a question or a command, to a virtual agent. In order to determine the most appropriate and/or helpful response to the query, the query is processed to determine a user intent to which the query corresponds, e.g. to interpret why the user has produced the query, what information or response the user desires, etc. Natural Language Understanding (NLU) may be used to determine the user intent. For this purpose, a virtual agent may use a classifier that is pre-trained to classify user queries according to a plurality of predefined user intents. As such, the query is processed using the classifier to determine one of the plurality of predefined user intents to which the query is predicted to correspond.

A virtual agent may be provided by a service provider serving multiple customers, each customer having respective users. The pre-trained classifier for determining user intents is common amongst the customers. That is, the virtual agent is shipped to each customer along with the pre-trained classifier. For many customers, the pre-trained classifier is sufficient to accurately determine user intents for received user queries. However, for some customers the pre-trained classifier is not sufficient. For example, a given customer may expect to receive user queries which correspond to user intents that are not included in the plurality of predefined user intents on which the classifier has been pre-trained. Such user intents may be specific to the business context of the given customer, for example.

The present disclosure seeks to mitigate the above-mentioned problems. Alternatively or additionally, the present disclosure seeks to provide an improved method of processing user queries for a virtual agent.

### SUMMARY

A first aspect of the present disclosure relates to a method of processing user queries for a virtual agent, the method comprising:

receiving data representing a user query directed to a virtual agent;

determining whether the user query corresponds to any one of a first plurality of predefined user intents, wherein the determining comprises first processing the received data using a first classifier configured to classify user queries according to the first plurality of user intents;

in response to a positive determination, generating first output data based on a user intent of the first plurality of predefined user intents to which the user query is determined to correspond;

in response to a negative determination, second processing the received data using a second classifier to generate second output data, the second classifier being configured to classify user queries according to a second plurality of predefined user intents; and

performing a predetermined action in relation to the virtual agent based on either the first output data or the second output data.

A second aspect of the present disclosure relates to a computer program product comprising a non-transitory computer-readable storage medium having computer-readable instructions stored thereon, the computer-readable storage medium being executable by a computerized device to cause the computerized device to perform a method of processing user queries for a virtual agent, the method comprising:

receiving data representing a user query directed to a virtual agent;

determining whether the user query corresponds to any one of a first plurality of predefined user intents, wherein the determining comprises first processing the received data using a first classifier configured to classify user queries according to the first plurality of user intents;

in response to a positive determination, generating first output data based on a user intent of the first plurality of predefined user intents to which the user query is determined to correspond;

in response to a negative determination, second processing the received data using a second classifier to generate second output data, the second classifier being configured to classify user queries according to a second plurality of predefined user intents; and

performing a predetermined action in relation to the virtual agent based on either the first output data or the second output data.

A third aspect of the present disclosure relates to an apparatus comprising:

at least one processor; and

at least one memory including computer program code,

wherein the at least one memory and the computer program code are configured to, with the at least one processor, cause the apparatus to:

receive data representing a user query directed to a virtual agent;

determine whether the user query corresponds to any one of a first plurality of predefined user intents, wherein the determining comprises first processing the received data using a first classifier configured to classify user queries according to the first plurality of user intents;

in response to a positive determination, generate first output data based on a user intent of the first plurality of predefined user intents to which the user query is determined to correspond;

in response to a negative determination, second process the received data using a second classifier to generate second output data, the second classifier being configured to classify user queries according to a second plurality of predefined user intents; and

perform a predetermined action in relation to the virtual agent based on either the first output data or the second output data.

A fourth aspect of the present disclosure relates to a method of processing user queries for a virtual agent, the method comprising:

receiving data representing a user query directed to a virtual agent;

first processing the received data using a first artificial neural network, ANN, the first ANN having been trained to classify user queries according to a first plurality of predefined user intents, wherein the first processing comprises performing, at the first ANN, out-of-domain detection based on the first plurality of predefined user intents;

in response to the first ANN determining that the user query is not out-of-domain, controlling the virtual agent based on a user intent of the first plurality of predefined user intents to which the user query is determined to correspond; and

in response to the first ANN determining that the user query is out-of-domain:
second processing the received data using a second ANN, the second ANN having been trained to classify user queries according to a second, different, plurality of predefined user intents; and
controlling the virtual agent based on a user intent of the second plurality of predefined user intents to which the user query is determined to correspond.

A fifth aspect of the present disclosure relates to a computer program product comprising a non-transitory computer-readable storage medium having computer-readable instructions stored thereon, the computer-readable storage medium being executable by a computerized device to cause the computerized device to perform a method of processing user queries for a virtual agent, the method comprising:

receiving data representing a user query directed to a virtual agent;

first processing the received data using a first artificial neural network, ANN, the first ANN having been trained to classify user queries according to a first plurality of predefined user intents, wherein the first processing comprises performing, at the first ANN, out-of-domain detection based on the first plurality of predefined user intents;

in response to the first ANN determining that the user query is not out-of-domain, controlling the virtual agent based on a user intent of the first plurality of predefined user intents to which the user query is determined to correspond; and

in response to the first ANN determining that the user query is out-of-domain:
second processing the received data using a second ANN, the second ANN having been trained to classify user queries according to a second, different, plurality of predefined user intents; and
controlling the virtual agent based on a user intent of the second plurality of predefined user intents to which the user query is determined to correspond.

A sixth aspect of the present disclosure relates to an apparatus comprising:

at least one processor; and

at least one memory including computer program code,

wherein the at least one memory and the computer program code are configured to, with the at least one processor, cause the apparatus to:

receive data representing a user query directed to a virtual agent;

first process the received data using a first artificial neural network, ANN, the first ANN having been trained to classify user queries according to a first plurality of predefined user intents, wherein the first processing comprises performing, at the first ANN, out-of-domain detection based on the first plurality of predefined user intents;

in response to the first ANN determining that the user query is not out-of-domain, control the virtual agent based on a user intent of the first plurality of predefined user intents to which the user query is determined to correspond; and

in response to the first ANN determining that the user query is out-of-domain:
second process the received data using a second ANN, the second ANN having been trained to classify user queries according to a second, different, plurality of predefined user intents; and
control the virtual agent based on a user intent of the second plurality of predefined user intents to which the user query is determined to correspond.

It will of course be appreciated that features described in relation to one aspect of the present disclosure may be incorporated into other aspects of the present disclosure. For example, the method of the present disclosure may incorporate any of the features described with reference to the apparatus of the present disclosure and vice versa.

### BRIEF DESCRIPTION OF THE DRAWINGS

FIG. 1 shows a flow diagram illustrating a method for training a classifier for a virtual agent according to embodiments of the present disclosure;

FIG. 2 shows a flow diagram illustrating a method of processing user queries for a virtual agent, according to embodiments of the present disclosure;

FIG. 3 shows a functional block diagram of a classifier according to embodiments of the present disclosure;

FIG. 4 shows a functional block diagram of a classifier according to embodiments of the present disclosure; and

FIG. 5 shows a flow chart illustrating a method of processing user queries for a virtual agent, according to embodiments of the present disclosure.

### DETAILED DESCRIPTION OF CERTAIN INVENTIVE EMBODIMENTS

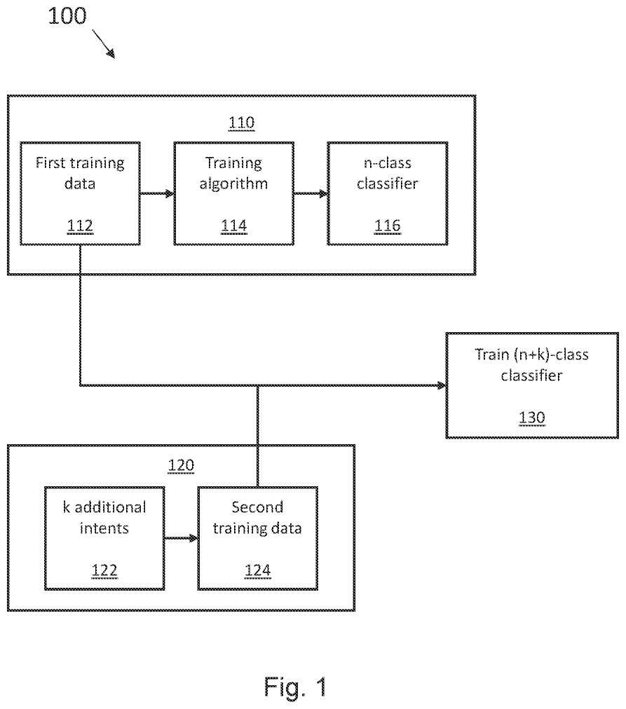

FIG. 1 shows a flow diagram of a method 100 for training a classifier for a virtual agent according to embodiments of the present disclosure.

In the embodiments of FIG. 1, a service provider 110 trains an n-class classifier 116 using first training data 112, TD1, and a training algorithm 114, e.g. based on supervised. The n-class classifier 116 may comprise an artificial neural network, for example. Each of the n classes comprises a particular user intent that user queries may correspond to. In embodiments, a user intent comprises a categorization of what a user intended or wanted when the user directed a given query to the virtual agent. The first training data 112 is associated with the n classes, e.g. comprising examples of queries and/or utterances corresponding to the n classes. The n-class classifier 116, once trained, is shipped to customers for use with a virtual agent. As such, the trained n-class classifier 116 is common across all customers.

In the embodiments of FIG. 1, a specific customer 120 served by the service provider 110 has k additional classes 122 according to which it is desired to classify user queries received via the virtual agent. Each of the k additional classes 122 comprises a particular user intent. In embodiments, the k additional classes 122 are non-overlapping with the n classes. In embodiments, the k additional classes 122 are customer-specific. For example, the k additional classes 122 may be associated with a customer-specific user intent domain. The customer 120 provides second training data 124, TD2, associated with the k additional classes 122, e.g. comprising examples of queries and/or utterances corresponding to the k additional classes. Both the first training data 112 and the second training data 124 are then used to train an (n+k)-class classifier 130. The (n+k)-class classifier 130, once trained, is used to classify user queries in place of the pre-trained n-class classifier 116 that is shipped with the virtual agent. As such, the method 100 of FIG. 1 involves adding customer-specific user intents to a set of pre-configured user intents by building a new classifier with all of the additional intents that the customer wishes to include.

The approach of FIG. 1 has two drawbacks, however. First, without direct access to the first training data 112, TD1, the customer may be unable optimize the performance of the (n+k)-class classifier. To optimize the performance of the (n+k)-class classifier, the overlap between TD1 and TD2 should be reduced. This may require the customers to have direct access to TD1, or alternatively possess a very high volume of training data in TD2. Many customers are not able to provide sufficiently high volumes of training data, however. Moreover, it may be undesirable to allow the customers to directly access TD1, which has been used by the service provider 110 to pre-train the n-class classifier 116 prior to shipping the virtual agent to customers. Second, when the service provider 110 improves the pre-built n-class classifier 116, providing an update to the customer 120 may involve a significant migration effort. This may force the service provider 110 to freeze the customer's (n+k)-class classifier 130 to one specific version and thereby lock the customer out of updates.

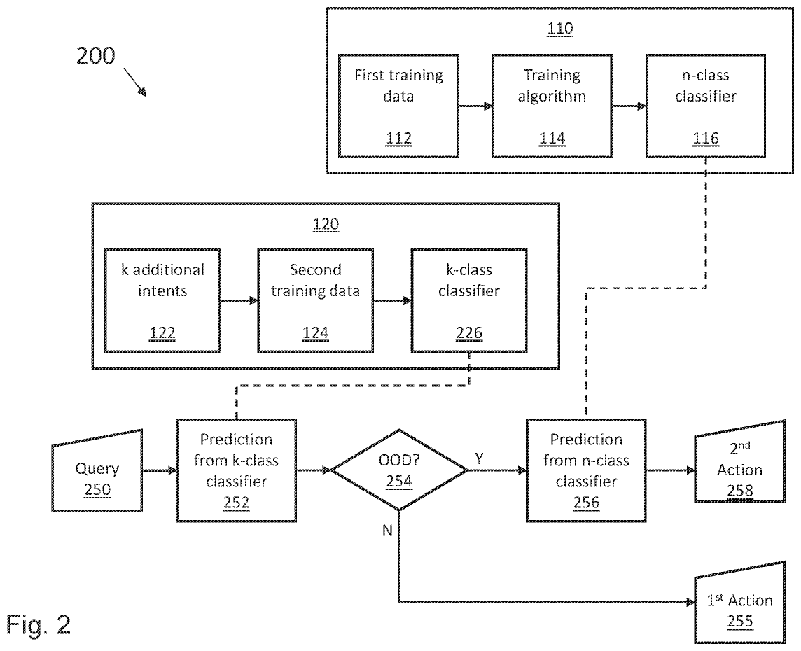

FIG. 2 shows a flow diagram illustrating a method 200 for processing user queries for a virtual agent, according to embodiments of the present disclosure.

In the embodiments of FIG. 2, the customer 120 trains a k-class classifier 226. The k-class classifier 226 is trained using the second training data 124 and is associated with the k additional user intents 122, i.e. each of the k classes of the k-class classifier 226 comprises a respective one of the k user intents 122. Two independent classifiers are thus available for use when processing user queries for a virtual agent: the n-class classifier 116 that is pre-trained by the service provider 110, and the k-class classifier 226 that is trained by the customer 120. The n-class classifier 116 is configured to classify queries according to n non-customer-specific user intents, whereas the k-class classifier 226 is configured to classify queries according to k customer-specific user intents. The k-class classifier 226 and the pre-trained n-class classifier 116 together form a hierarchical classification system, as described below. Unlike the (n+k)-class classifier 130 described above with reference to FIG. 1, which is dependent on the n pre-configured user intents as well as the k customer-specific user intents, the hierarchical classification system shown in FIG. 2 comprises two separate and independent classifiers, each trained using separate training data.

In embodiments, the k-class classifier 226 is configured to perform out-of-domain detection. In other words, the k-class classifier 226 is configured to detect out-of-domain queries. In embodiments, a query is determined to be out-of-domain when it is determined not to correspond to any one of the k user intents specified by the customer 120.

The method 200 comprises receiving a query 250 via a virtual agent. When the query 250 is received via the virtual agent, the query 250 is processed 252 using the k-class classifier 226. In embodiments, processing the query 250 using the k-class classifier 226 comprises calculating, for each of the k user intents, a probability that the query 250 corresponds to the given user intent. The calculated probability corresponds to a prediction of whether or not the query corresponds to the given user intent. For example, the calculated probability may be compared with a threshold. If the calculated probability exceeds the threshold, it is predicted that the query corresponds to the given user intent. If the calculated probability does not exceed the threshold, it is predicted that the query does not correspond to the given user intent. Accordingly, the query may be classified according to the k user intents.

In the embodiments of FIG. 2, the method 200 comprises determining 254 whether or not the query 250 is out-of-domain of the k-class classifier 226. In other words, it is determined whether the query 250 corresponds to any one of the k user intents, or none of the k user intents. In embodiments, each of the k user intents is associated with a common user intent domain. As such, a determination that the query 250 does not correspond to any of the k user intents implies that the query 250 is out-of-domain of the k-class classifier 226.

If it is determined that the query 250 is not out-of-domain (i.e. that the query 250 does correspond to one of the k classes), a first action 255 is performed. The first action 255 is based on a user intent of the k customer-specific user intents to which the query 250 is determined to correspond, e.g. based on the predictions performed by the k-class classifier 226. For example, a user intent of the k user intents having the highest probability as calculated by the k-class classifier 226 may be selected as being the user intent to which the user query corresponds. The first action 255 may be different for different user intents of the k user intents. In embodiments, the first action 255 is specified by the customer 120. That is, the customer 120 may specify that, when a query is determined to correspond to a particular user intent, a particular action is performed. The first action 255 is performed in relation to the virtual agent. For example, the first action 255 may comprise controlling the virtual agent, e.g. to cause the virtual agent to provide a particular response to the query. In embodiments, the first action 255 comprises connecting the user to a human agent. In embodiments, the first action 255 comprises closing an instance of the virtual agent, e.g. if the user is being connected to a human agent, the instance of the virtual agent with which the user is interacting may be closed.

If it is determined at step 254 that the query 250 is out-of-domain, the query 250 is processed 256 using the n-class classifier 116. That is, query processing defaults to the n-class classifier 116 if the query is determined to be out-of-domain of the k-class classifier 226. In embodiments, processing the query 250 using the n-class classifier 116 comprises determining a user intent of the n user intents to which the query 250 is most likely to correspond. In embodiments, processing the query 250 using the n-class classifier 116 comprises calculating, for each of the n user intents, a probability that the query 250 corresponds to that given user intent. The user intent of the n user intents having the highest calculated probability may then be selected. Accordingly, the query may be classified according to the n user intents.

In embodiments, after classifying the query 250 using the n-class classifier 116, a second action 258 is performed. The second action 258 is based on a user intent of the n non-customer-specific user intents to which the query 250 is determined to correspond, e.g. based on the predictions performed by the n-classifier 116. The second action 258 may be different for different user intents of the n user intents. In embodiments, the second action 258 is specified by the service provider 110. That is, the service provider 110 may specify that, when a query is determined to correspond to a particular user intent of the n non-customer-specific user intents, a particular action is performed. The second action 258 is performed in relation to the virtual agent. For example, the second action 258 may comprise controlling the virtual agent, e.g. to cause the virtual agent to provide a particular response to the query 250. In embodiments, the second action 258 comprises connecting the user to a human agent. In embodiments, the second action 258 comprises closing an instance of the virtual agent, e.g. if the user is being connected to a human agent, the instance of the virtual agent with which the user is interacting may be closed.

As such, either the first action 255 or the second action 258 is performed, depending on whether or not the query 250 is determined to be out-of-domain of the k-class classifier 226. In embodiments, the first action 255 and the second action 258 are different actions. However, it will be understood that in some cases the first action 255 and the second action 258 may comprise the same action. For example, both the first action 255 and the second action 258 may comprise connecting the user to a human agent, or causing the virtual agent to provide a particular output for the user.

Although steps 252 and 254 are shown in FIG. 2 as being separate, it will be understood that these steps may be performed together, e.g. as a single step. That is, the k-class classifier 226 may be configured to determine in a single process whether the query is out-of-domain and, if the query is not out-of-domain, which of the k classes the query corresponds to.

By decoupling the pre-trained n-class classifier 116 from the customer-built k-class classifier 226, the customer 120 can independently optimize the performance of the k-class classifier 226 for the k user intents 122 that are relevant to the customer 120 and using the training data 124 that the customer 120 possesses. Any query that is detected as being out-of-domain of the customer's classifier 226 is then redirected to the pre-trained n-class classifier 116 provided by the service provider 110. The customer 120 therefore does not require access to the first training data 112 used to train the n-class classifier 116. Moreover, the service provider 110 can roll out improvements of the n-class classifier 116 to customers without impacting the reliability of the overall system, because the customer's k-class classifier 226 is de-coupled from (and independent of) the n-class classifier 116. This provides an improved method of processing user queries for a virtual agent.

In embodiments, each customer served by the service provider 110 has its own customer-specific classifier, as well as having access to the n-class classifier 116 which is common across all customers. That is, each customer builds a specific classifier for their own use cases (e.g. having user intents which are relevant to the customer's particular business function). The customer-specific classifier is used to attempt to classify queries initially, and if the query is out-of-domain of the customer-specific classifier, query processing falls back to the pre-trained n-class classifier 116. In embodiments, the customer-specific classifier of a given customer is customizable by the given customer. In alternative embodiments, one or more customers served by the service provider 110 do not have their own customer-specific classifiers. Such customers may use only the pre-trained n-class classifier 116, for example.

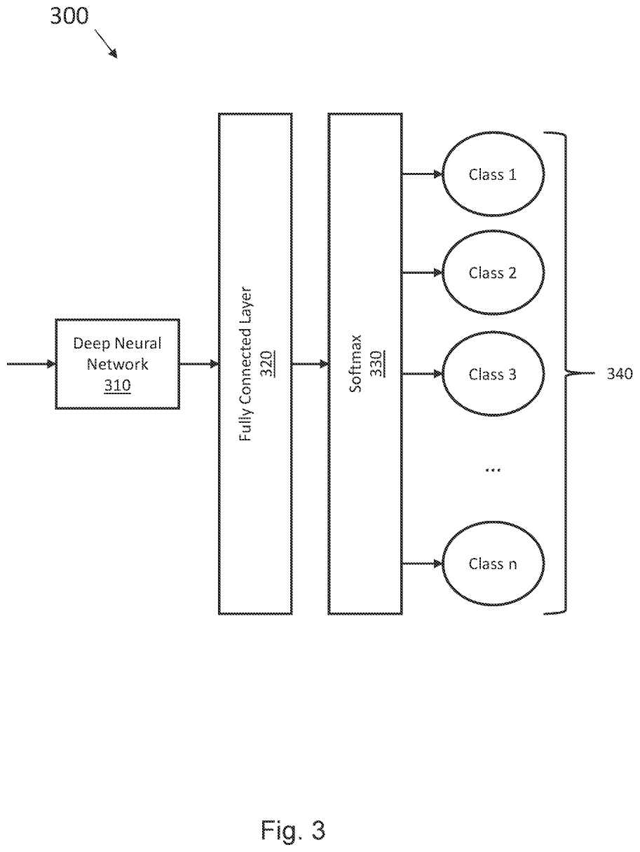

FIG. 3 shows a functional block diagram of a classifier 300 according to embodiments of the present disclosure. The classifier 300 is configured to classify queries according to a plurality of classes. The classifier 300 may be used as one or more of the n-class classifier 116, the (n+k)-class classifier 130, and the k-class classifier 226 described with reference to FIGS. 1 and 2 above. The classifier 300 comprises a deep neural network 310 with one or more fully connected layers 320, and a Softmax output layer 330. The Softmax output layer 330 is used as the activation function for classifying queries according to a plurality of classes. In embodiments, the Softmax output layer 330 is used to normalize the output of the neural network 310 to a probability distribution over predicted output classes. The Softmax output layer 330 produces, for each of the plurality of classes, a probability 340 between 0 and 1, where the sum of the probabilities 340 across the plurality of classes equals 1. The class having the highest probability is predicted to be the class to which the query corresponds.

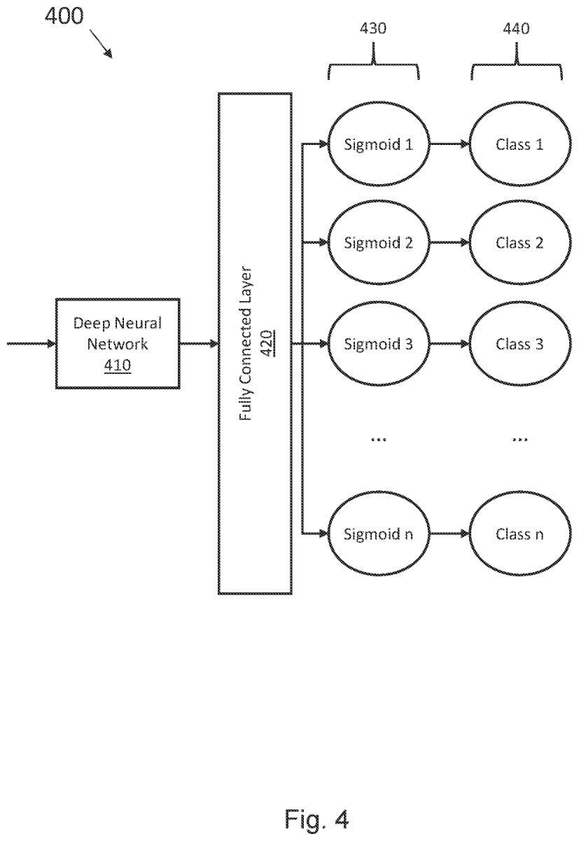

FIG. 4 shows a functional block diagram of a classifier 400 according to embodiments of the present disclosure. The classifier 400 is configured to classify queries according to a plurality of classes. The classifier 400 may be used as one or more of the n-class classifier 116, the (n+k)-class classifier 130, and the k-class classifier 226 described with reference to FIGS. 1 and 2 above. The classifier 400 comprises a deep neural network 410 with one or more fully connected layers 420. Compared to the classifier 300 shown in FIG. 3, the classifier 400 of FIG. 4 uses a plurality of sigmoid functions 430 in place of the Softmax output layer 330. Each of the sigmoid functions 430 corresponds to a respective class of the plurality of classes, and produces a probability score 440 for the respective class. This configuration enables the classifier 400 to function as an out-of-domain detector. If none of the probability scores 440 produced by the sigmoid functions 430 is above a predetermined threshold, the query is determined to be out-of-domain. If multiple sigmoid functions 430 produce a probability score that is above the predetermined threshold, then the class that has the highest probability score is selected as the class to which the query is predicted to correspond.

In embodiments, the predetermined threshold is a variable threshold. That is, the predetermined threshold may be different for different classes of the plurality of classes. In other words, the predetermined threshold may be dependent on the class that is being considered. The value of the predetermined threshold for a given class may be controlled by an external parameter, alpha. In embodiments, alpha is a number of standard deviations away from a mean value of the predetermined threshold that would still qualify as a positive result for that class. Using a predetermined threshold which varies according to class enables anomalies to be detected, and provides more accurate and/or reliable classification results. In alternative embodiments, the predetermined threshold has a fixed value across all classes, e.g. a value of 0.5.

In embodiments, the classifier 400 is trained by minimizing the cumulative negative log-likelihood across the plurality of classes. The classifier 400 may be trained using training data, e.g. comprising utterances corresponding to each class. Other training methods and/or loss functions may be used in alternative embodiments, e.g. using cross entropy, stochastic gradient descent, etc.

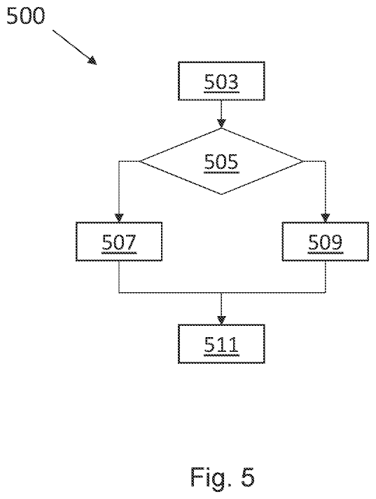

FIG. 5 shows a flow chart illustrating a method 500 of processing user queries for a virtual agent according to embodiments of the present disclosure.

A first step of the method 500, represented by item 503, comprises receiving data representing a user query directed to a virtual agent. In embodiments, the user query comprises a question and/or a command directed to the virtual agent. In embodiments, the received data comprises text data and/or audio data received via the virtual agent. For example, if a user has spoken a query into a microphone, the received data may comprise audio data generated by the microphone based on the query. Similarly, if a user has typed a query into a textbox, the received data may comprise text data indicative of the query.

A second step of the method 500, represented by item 505, comprises determining whether the user query corresponds to any one of a first plurality of predefined user intents. The determining comprises first processing the received data using a first classifier. The first classifier is configured to classify user queries according to the first plurality of user intents. In embodiments, the first classifier comprises a customer-specific classifier, and the first plurality of predefined user intents comprise a plurality of customer-defined user intents. In embodiments, the determining comprises performing out-of-domain detection based on the first plurality of predefined user intents. In embodiments, the first classifier comprises an artificial neural network, ANN. ANNs may produce more accurate and/or reliable classification results than classifiers other than ANNs. For example, the first classifier may comprise a deep neural network. In embodiments, the first classifier comprises a classifier such as the classifier 400 described with reference to FIG. 4 above. In embodiments, the first classifier comprises a plurality of sigmoid functions. Each of the plurality of sigmoid functions corresponds to a respective one of the first plurality of predefined user intents. The use of sigmoid functions enables the first classifier to function as an out-of-domain detector. In embodiments, the determining comprises, for each of the first plurality of predefined user intents, calculating a probability that the user query corresponds to the predefined user intent, and comparing the calculated probability with a threshold. In embodiments, the threshold has a value that is dependent on the predefined user intent. That is, the threshold may have a first value for a first user intent of the first plurality of predefined user intents, and a second value for a second user intent of the first plurality of predefined user intents. This provides more accurate and/or reliable classification results, e.g. by handling anomalies wherein queries corresponding to particular user intents may be more likely to be misclassified than queries corresponding to other user intents. In alternative embodiments, the first classifier comprises a classifier such as the classifier 300 described with reference to FIG. 3 above, e.g. a deep neural network configured to use a Softmax output layer.

In response to a positive determination at item 505, a third step of the method 500 is performed, represented by item 507. The third step comprises generating first output data based on a user intent of the first plurality of predefined user intents to which the user query is determined to correspond. In embodiments, the first output data is indicative of the user intent of the first plurality of predefined user intents to which the user query is determined to correspond. In embodiments, the first output data is indicative of an action that is to be performed in response to the user query, the action being dependent on the user intent of the first plurality of predefined user intents to which the user query is determined to correspond. In embodiments, the action is a customer-defined action. Such an action may comprise providing a particular output to the user via the virtual agent, for example. In embodiments, the method 500 comprises a step (not shown) of determining the user intent of the first plurality of predefined user intents to which the user query corresponds, e.g. classifying the user query according to the first plurality of predefined user intents. Such a step may be performed in combination with, or separately from, the determination step 505.

In response to a negative determination at item 505, a fourth step of the method 500 is performed, represented by item 509. The fourth step comprises second processing the received data using a second classifier to generate second output data. As such, processing of the received data defaults to the second classifier if it is determined that the query does not correspond to any of the first plurality of predefined user intents. The second classifier is configured to classify user queries according to a second plurality of predefined user intents. In embodiments, the second classifier comprises a non-customer-specific classifier, and the second plurality of predefined user intents comprises a plurality of non-customer-defined user intents. In embodiments, the second plurality of predefined user intents are defined by a service provider serving multiple customers.

In embodiments, the first classifier is independent of the second classifier. That is, in embodiments, the first classifier is not dependent on the second classifier, and vice-versa. As such, the first classifier may be modified and/or updated without affecting or requiring any change to the second classifier. Similarly, the second classifier may be modified and/or updated without affecting or requiring any change to the first classifier. In embodiments, the second classifier comprises an artificial neural network, e.g. a deep neural network. In embodiments, the second classifier comprises a classifier such as the classifier 400 described with reference to FIG. 4 above. In alternative embodiments, the second classifier comprises a classifier such as the classifier 300 described with reference to FIG. 3 above. In embodiments, the second classifier is configured to perform out-of-domain detection based on the second plurality of predefined user intents. In alternative embodiments, the second classifier is not configured to perform out-of-domain detection. In embodiments, the second processing comprises determining that the user query corresponds to a user intent of the second plurality of predefined user intents. In alternative embodiments, the second processing comprises determining that the user query does not correspond to any of the second plurality of predefined user intents.

In embodiments, the first plurality of predefined user intents and the second plurality of predefined user intents are mutually exclusive, i.e. non-overlapping. That is, the first plurality of predefined user intents and the second plurality of predefined user intents may have no user intents in common. In alternative embodiments, the first plurality of predefined user intents overlaps with the second plurality of predefined user intents. In other words, the first plurality of predefined user intents and the second plurality of predefined user intents may have one or more user intents in common. In embodiments, the first plurality of predefined user intents are customer-specific, whereas the second plurality of predefined user intents are not customer-specific. The first classifier and/or the first plurality of predefined user intents may thus be tailored to a particular customer. In embodiments, the first plurality of predefined user intents are identified by a particular customer, whereas the second plurality of predefined user intents may be identified by a service provider serving multiple customers. In embodiments, the first plurality of predefined user intents comprises a first number of user intents, and the second plurality of predefined user intents comprises a second, greater number of user intents. The first plurality of predefined user intents may be focused on a particular business function or context of a customer, for example, whereas the second plurality of predefined user intents may be more generally applied across any customer. In alternative embodiments, the first plurality of predefined user intents comprises a greater number of user intents than the second plurality of predefined user intents. In embodiments, each of the first plurality of predefined user intents is associated with a common user intent domain. The common user intent domain may be associated with a business function of a specific customer, for example. In some such embodiments, the first classifier is configured to classify user queries in the common user intent domain, and the second classifier is configured to classify user queries outside the common user intent domain. As such, in-domain queries and out-of-domain queries are classified using separate classifiers.

In embodiments, the second output data is indicative of a user intent of the second plurality of predefined user intents to which the user query is determined to correspond. In embodiments, the second output data is indicative of an action that is to be performed in response to the user query, the action being dependent on the user intent of the second plurality of predefined user intents to which the user query is determined to correspond. In alternative embodiments, the second output data indicates that the query does not correspond to any of the second plurality of predefined user intents. In embodiments, the action is a service provider-defined action. In embodiments, the method 500 comprises a step (not shown) of determining a user intent of the second plurality of predefined user intents to which the user query corresponds, e.g. by classifying the user query using the second classifier.

A fifth step of the method 500, represented by item 511, comprises performing a predetermined action in relation to the virtual agent based on either the first output data or the second output data. In embodiments, the predetermined action comprises controlling the virtual agent. In embodiments, the predetermined action comprises causing the virtual agent to provide an output for a user. Such an output may be dependent on the user intent to which the user query is determined to correspond. In embodiments, the predetermined action comprises a first action if the first output data has been generated, and a second, different action if the second output data has been generated. Examples of predetermined actions include, but are not limited to, causing the virtual agent to provide information to a user, causing the virtual agent to request information from the user, causing the virtual agent to attempt to retrieve information from a further entity (e.g. from a database), establishing a connection between the user and a human agent, and closing an instance of the virtual agent.

In embodiments, the method 500 comprises an initial step (not shown) comprising training the first classifier. In some such embodiments, the first classifier is trained by minimizing a cumulative negative log-likelihood over the first plurality of predefined user intents. In embodiments, the first classifier is trained using first training data. The first training data is associated with the first plurality of predefined user intents. For example, the first training data may comprise utterances corresponding to each of the first plurality of user intents. In alternative embodiments, the first classifier has already been trained when the method 500 is performed.

In embodiments, the second classifier has been trained using second, different training data. The second training data is associated with the second plurality of predefined user intents. In embodiments, the method 500 comprises the step (not shown) of receiving the second classifier. The second classifier may have been pre-trained to classify queries according to the second plurality of user intents when the second classifier is received.

In embodiments, the first training data comprises a first amount of training data, and the second training data comprises a second, greater amount of training data. In embodiments, the first training data is provided by a customer, and the second training data is provided by a service provider serving multiple customers. The service provider may have access to a greater amount of training data than the customer. The first training data may be focused on a relatively small number of customer-specific user intents, whereas the second training data may be applicable to a relatively large number of non-customer-specific user intents. In embodiments, the first classifier is trained by the customer to classify user queries according to customer-specific user intents using training data provided by the customer. As such, the first classifier may be trained independently of the service provider. In embodiments, the second classifier is trained by the service provider to classify queries according to non-customer-specific user intents using training data of the service provider. As such, the second classifier may be trained independently of the customer.

Whilst the present disclosure has been described and illustrated with reference to particular embodiments, it will be appreciated by those of ordinary skill in the art that the present disclosure lends itself to many different variations not specifically illustrated herein.

In embodiments described above, the first classifier is a customer-specific classifier and the second classifier is common to all customers served by a service provider. In alternative embodiments, the first classifier is common to all customers and the second classifier is a customer-specific classifier. That is, in embodiments, queries may initially be processed using a classifier that is common to all customers (e.g. a classifier that is shipped to customers with the virtual agent), and if it is determined that a query is out-of-domain of that classifier, the query may be processed using a customer-specific classifier.

In embodiments, the second classifier may be updated based on the first classifier and/or the first training data. For example, a customer may provide the first classifier and/or the first training data to the service provider, and the service provider may modify the second classifier such that the second classify can classify user queries according to the first plurality of predefined user intents as well as the first plurality of predefined user intents. The modified second classifier may then be distributed to other customers, for example. This increases the versatility of the second classifier.

One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also include computer programs, particularly computer programs on or in a carrier, adapted for putting the above-described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

The one or more processors may comprise data storage. The data storage may comprise one or both of volatile and non-volatile memory. The data storage may comprise one or more of random access memory (RAM), read-only memory (ROM), a magnetic or optical disk and disk drive, or a solid-state drive (SSD). It will be appreciated by the skilled person that many other types of memory, in addition to the examples provided, may also be used. It will be appreciated by a person skilled in the art that the one or more processors may each comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the present disclosure that are described as preferable, advantageous, convenient or the like are optional and do not limit the scope of the independent claims. Moreover, it is to be understood that such optional integers or features, whilst of possible benefit in some embodiments of the present disclosure, may not be desirable, and may therefore be absent, in other embodiments.

What is claimed is:

1. A method of processing user queries for a virtual agent, the method comprising:
receiving data representing a user query directed to the virtual agent;
determining whether the user query corresponds to any one of a first plurality of predefined user intents, wherein the determining comprises first processing the received data using a first classifier configured to classify user queries according to the first plurality of predefined user intents;
in response to a positive determination, generating first output data based on a user intent of the first plurality of predefined user intents to which the user query is determined to correspond;
in response to a negative determination, second processing the received data using a second classifier to generate second output data, the second classifier being configured to classify user queries according to a second plurality of predefined user intents; and
performing a predetermined action in relation to the virtual agent based on either the first output data or the second output data.

2. The method of claim 1, wherein the determining comprises performing out-of-domain detection based on the first plurality of predefined user intents.

3. The method of claim 1, wherein the first classifier is independent of the second classifier.

4. The method of claim 1, wherein the first plurality of predefined user intents and the second plurality of predefined user intents are mutually exclusive.

5. The method of claim 1, wherein the first plurality of predefined user intents overlaps with the second plurality of predefined user intents.

6. The method of claim 1, wherein the first classifier comprises an artificial neural network.

7. The method of claim 1, wherein the first classifier comprises a plurality of sigmoid functions, each of the plurality of sigmoid functions corresponding to a respective one of the first plurality of predefined user intents.

8. The method of claim 1, wherein the determining comprises, for each of the first plurality of predefined user intents:
calculating a probability that the user query corresponds to the predefined user intent; and
comparing the calculated probability with a threshold, the threshold having a value that is dependent on the predefined user intent.

9. The method of claim 1, comprising training the first classifier by minimizing a cumulative negative log-likelihood over the first plurality of predefined user intents.

10. The method of claim 1, wherein the second classifier is configured to perform out-of-domain detection based on the second plurality of predefined user intents.

11. The method of claim 1, wherein the second classifier comprises an artificial neural network.

12. The method of claim 1, wherein the second processing comprises determining that the user query corresponds to a user intent of the second plurality of predefined user intents.

13. The method of claim 1,
wherein the method comprises training the first classifier using first training data, the first training data associated with the first plurality of predefined user intents,
wherein the second classifier has been trained using second, different training data, the second training data associated with the second plurality of predefined user intents, and
wherein the first training data comprises a first amount of training data, and the second training data comprises a second, greater amount of training data.

14. The method of claim 1, wherein the first plurality of predefined user intents comprises a first number of user intents, and the second plurality of predefined user intents comprises a second, greater number of user intents.

15. The method of claim 1,
wherein each of the first plurality of predefined user intents is associated with a common user intent domain,
wherein the first classifier is configured to classify user queries in the common user intent domain, and
wherein the second classifier is configured to classify user queries outside the common user intent domain.

16. The method of claim 1, wherein the predetermined action comprises causing the virtual agent to provide an output for a user.

17. The method of claim 1, wherein the received data comprises text data and/or audio data received via the virtual agent.

18. The method of claim 1, wherein the user query comprises a question and/or a command directed to the virtual agent.

19. A computer program product comprising a non-transitory computer-readable storage medium having computer-readable instructions stored thereon, the computer-readable storage medium being executable by a computerized device to cause the computerized device to perform a method of processing user queries for a virtual agent, the method comprising:
receiving data representing a user query directed to the virtual agent;
determining whether the user query corresponds to any one of a first plurality of predefined user intents, wherein the determining comprises first processing the received data using a first classifier configured to classify user queries according to the first plurality of predefined user intents;
in response to a positive determination, generating first output data based on a user intent of the first plurality of predefined user intents to which the user query is determined to correspond;
in response to a negative determination, second processing the received data using a second classifier to generate second output data, the second classifier being configured to classify user queries according to a second plurality of predefined user intents; and
performing a predetermined action in relation to the virtual agent based on either the first output data or the second output data.

20. An apparatus comprising:
at least one processor; and
at least one memory including computer program code,
wherein the at least one memory and the computer program code are configured to, with the at least one processor, cause the apparatus to:
receive data representing a user query directed to a virtual agent;
first process the received data using a first artificial neural network, ANN, the first ANN having been trained to classify user queries according to a first plurality of predefined user intents, wherein the first processing comprises performing, at the first ANN, out-of-domain detection based on the first plurality of predefined user intents;
in response to the first ANN determining that the user query is not out-of-domain, control the virtual agent based on a user intent of the first plurality of predefined user intents to which the user query is determined to correspond; and
in response to the first ANN determining that the user query is out-of-domain:
second process the received data using a second ANN, the second ANN having been trained to classify user queries according to a second, different, plurality of predefined user intents; and
control the virtual agent based on a user intent of the second plurality of predefined user intents to which the user query is determined to correspond.
